(19) United States
(12) Patent Application Publication
(10) Pub. No.: US 2026/0124977 A1
(43) Pub. Date: May 7, 2026

(54) VEHICLE CONSOLE HAVING TRAY WITH EXPOSED CUP HOLDER

(71) Applicant: Ford Global Technologies, LLC, Dearborn, MI (US)

(72) Inventors: Luis Enrique Gloria Talavera, Mexico City (MX); Ignacio Adán Bautista Hernández, Nicolas Romero (MX); Nevid Misael Meza Rodriguez, Tlalnepantla de Baz (MX); Juan Angel Palencia Morales, Mexico City (MX); Alan Fernando Tinoco Jiménez, Mexico City (MX)

(73) Assignee: Ford Global Technologies, LLC, Dearborn, MI (US)

(21) Appl. No.: 18/937,133

(22) Filed: Nov. 5, 2024

(51) Int. Cl. B60N 2/75; B60N 3/10

(52) U.S. Cl. CPC B60N 2/793; B60N 3/102

(57) ABSTRACT

A vehicle console includes a housing having sidewalls defining a storage compartment having a top access opening of a first size having a first length and a lid coupled to the housing and moveable between an open position and a closed position. The lid has a second size with a second length that is less than the first length so as to expose a portion of the top access opening when the lid is in the closed position. A first tray is disposed within the storage compartment and configured with a cup holder located below the exposed open top such that a container when placed in the cup holder is exposed.

### FIELD OF THE DISCLOSURE

The present disclosure generally relates to a console arrangements for motor vehicles, and more specifically relates to a vehicle console having a tray with an accessible cup holder.

### BACKGROUND OF THE DISCLOSURE

Motor vehicles are commonly equipped with storage compartments, such as consoles. For example, a center console is often installed between a driver's seat and a passenger's seat in a front row of seating in a passenger motor vehicle. The center console typically has a main storage compartment with a lid which also serves as an arm rest and may include one or more drink holders and storage trays. It would be desirable to provide for a center console which offers a tray with enhanced availability of a cup holder.

### SUMMARY OF THE DISCLOSURE

According to a first aspect of the present disclosure, a vehicle console includes a housing having sidewalls defining a storage compartment having a top access opening of a first size having a first length and a lid coupled to the housing and moveable between an open position and a closed position. The lid has a second size with a second length that is less than the first length so as to expose a portion of the top access opening when the lid is in the closed position. A first tray is disposed within the storage compartment and configured with a cup holder located below the exposed open top such that a container when placed in the cup holder is exposed.

Embodiments of the first aspect of the present disclosure can include any one or a combination of the following features:
the exposed open top is on a vehicle forward portion of the top access opening;
the lid pivots about a hinge at a rearward portion of the housing;
the tray comprises one or more open tray portions;
the first tray comprises first and second open tray portions;
a second tray disposed above the first tray, wherein the second tray is configured to be positioned within the exposed open top and moveable to a position below the lid;
the second tray is supported on a track proximate the top access opening;
the first tray is supported on a bottom of the storage compartment;
the top access opening and the lid are generally rectangular; and
the console is a center console configured to be positioned between the first and second seats.

According to a second aspect of the present disclosure, a vehicle has a first seat, a second seat spaced from the first seat and a center console located between the first and second seats. The center console includes a housing having sidewalls defining a storage compartment having a top access opening of a first size having a first length and a lid coupled to the housing and moveable between an open position and a closed position. The lid has a second size with a second length that is less than the first length so as to expose a portion of the top access opening when the lid is in the closed position. A first tray is disposed within the storage compartment and configured with a cup holder located below the exposed open top such that a container when placed in the cup holder is exposed.

Embodiments of the second aspect of the present disclosure can include any one or a combination of the following features:
the exposed open top is on a vehicle forward portion of the top access opening;
the lid pivots about a hinge at a rearward portion of the housing;
the tray comprises one or more open tray portions;
the first tray comprises first and second open tray portions;
a second tray disposed above the first tray, wherein the second tray is configured to be positioned within the exposed open top and moveable to a position below the lid;
the second tray is supported on a track proximate the top access opening;
the first tray is supported on a bottom of the storage compartment;
the top access opening and the lid are generally rectangular; and
the console is a center console configured to be positioned between the first and second seats.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper side perspective view of a cabin interior of a motor vehicle equipped with a front center console having a lower first media tray with a cup holder, according to one embodiment;

FIG. 2 is an elevated side perspective view of the center console with an upper second media tray exposed forward of a lid;

FIG. 3 is an upper side perspective view of the center console with the lid in the open position and the upper second media tray in the forwardmost position;

FIG. 4 is an upper side perspective view of the center console with a lower first media tray located forward of the upper second media tray;

FIG. 5 is an upper side perspective view of the center console with the lid in the closed position and the lower first media tray and cup holder exposed forward of the lid;

FIG. 6 is an upper side perspective view of the center console with the lid in the closed position as shown in FIG. 5 and a drink container located in the cup holder; and

FIG. 7 is an exploded perspective view of the center console with the first and second media trays exploded from the console.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

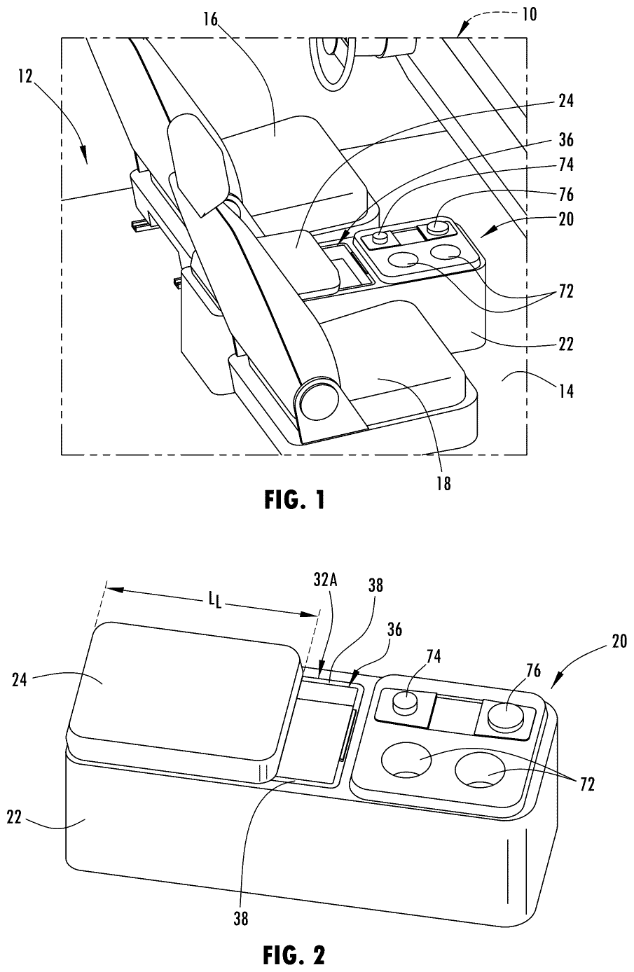

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle console having a tray with a drink holder.

Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-7, a vehicle console 20 is illustrated for use on a motor vehicle 10. The vehicle console 20 includes a housing 22 having sidewalls defining a storage compartment 30 having an open top end of a first size having a first length L_{O}. A lid 24 is matingly coupled to the housing and has a second size with a second length L_{L}. The second length L_{L} is less than the first length L_{O} so as to expose a portion of the open top end when the lid 24 is in the closed position. A first tray 40 is disposed within the storage compartment 30 and configured with a cup holder 50 located directly below the exposed open top such that a container, such as a drink container, when placed in the cup holder 50 is exposed and readily accessible.

Referring particularly to FIG. 1, a motor vehicle 10, such as a wheeled motor vehicle, is generally illustrated configured with passenger seating for transporting one or more passengers including a driver of the motor vehicle 10 for further transporting one or more cargo items onboard the motor vehicle 10. The motor vehicle 10 has a vehicle body that generally defines a cabin interior 12. The cabin interior 12 may contain various features and trim components. The cabin interior 12 is shown having an arrangement of front row of passenger seats including a first seat assembly 16 configured to seat a driver and a second seat assembly 18 configured to seat a passenger. The first and second seat assemblies 16 and 18 may be configured as Captain seats, for example, laterally spaced apart and separated by a space that is consumed by a front center console 20 that may be configured with at least one media tray, according to one embodiment as shown and described herein.

The motor vehicle 10 may include additional seating such as a second row of seating which may include third and fourth seat assemblies, for example, that may be spaced apart and may be separated by another center console that could be configured according to other embodiments as shown and described herein. The motor vehicle 10 may include additional rows of seating such as a third row of seating for extended vehicles which may likewise include additional center consoles located between seat assemblies. The motor vehicle 10 may include additional seating and consoles as is common for a large van or a bus, for example. It should be appreciated that the vehicle 10 may be a motor vehicle such as a wheeled car, truck, SUV, van or bus, for example, or an airplane, train, boat or other vehicle capable of transporting one or more passengers and cargo items.

The motor vehicle 10 is illustrated configured with a front row of seating having the first seat assembly 16 located on one lateral side (e.g., the left side) of the first row and vehicle rearward of a steering wheel and dashboard and configured for seating a driver of the vehicle 10. The first seat assembly 16 may include a seat base and a seat back. The second seat assembly 18 is shown positioned vehicle rearward of the dashboard on the opposite lateral side (e.g., right side) of the front row of seating and may likewise have a seat base and a seat back configured for seating a passenger. It should be appreciated that the motor vehicle 10 may be equipped with a plurality of side access doors located proximate to the first row of seating to allow the driver and passengers to enter and exit the cabin interior 12 to access the first and second seat assemblies 16 and 18.

The cabin interior 12 is shown equipped with a front center console 20 located in the space between the driver first seat assembly 16 and the passenger second seat assembly 18 in the front row of seating. The front center console 20 is one example of a vehicle console that may be equipped with one or more trays, such as media trays, having a cup holder as shown and described herein. It should further be appreciated that other configurations of vehicle consoles may include the arrangement of a media tray and cup holder including a rear center console spaced between seats within a second or third row of seating, for example, and may include other consoles located on the motor vehicle 10, according to other examples.

The vehicle console 20 generally has a housing 22 that is supported on a floor 14 between the first and second seat assemblies 16 and 18 in the cabin interior 12. It should be appreciated that the housing 22 may be resting on the underlying vehicle floor 14 or may include an intermediate layer such as a base, according to another example. The housing 22 is essentially fixed to the underlying support structure via fasteners such as screws or bolts or may be welded or may otherwise be fixedly connected to the support structure.

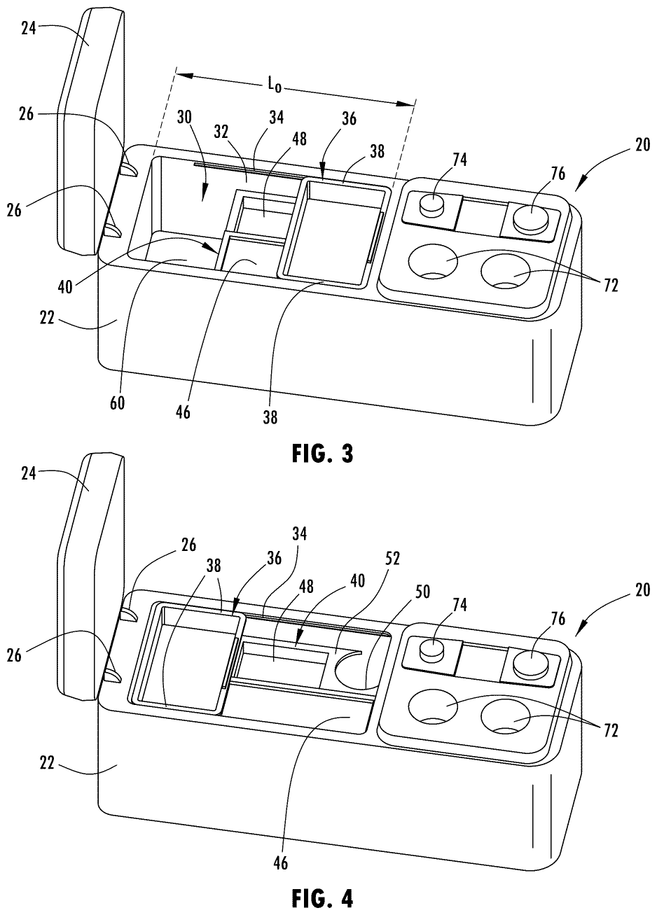

The vehicle console 20 is shown in FIGS. 2 and 3 configured in a generally rectangular configuration having upstanding sidewalls that define a main storage compartment 30 having a top access opening 32. The top access opening 32 is shown having a first size generally rectangularly configured opening with a first length L_{O} extending between the vehicle rearward and forward ends of the top access opening 32. The top access opening 32 is further shown partially covered by an armrest lid 24 which serves as a lid to cover a portion of the top access opening and an armrest for a driver or passenger to rest their arm upon. The armrest lid 24 is connected to a vehicle rearend portion of the housing 22 on top via a pair of hinges 26 and 28. The hinges 26 and 28 allow the armrest lid 24 to rotate between an open vertical position as seen in FIG. 3 and a downward closed covering position that covers a portion of the top access opening 32 as shown in FIG. 2. The front end of the armrest lid 24 may further include one or more latches to latch the armrest lid 24 on the top of the housing 22 in the closed position.

The armrest lid 24 is configured having a second size that is generally rectangular and having a second length L_{L} extending between the rearward and frontward edges of the armrest lid 24. The second size and second length L_{L} of the armrest lid 24 is smaller than the first size and first length L_{O} of the top access opening 32 of the storage compartment 30 such that when the armrest lid 24 is in the closed position as seen in FIG. 2, a front portion of the open top lid is exposed as shown by the exposed open top portion 32A in FIG. 2. As such, a user may access the storage compartment 30 through the open top portion 32A when the armrest lid 24 is in the closed position.

The center console 20 further includes an upper second tray 36 that is shown having a generally rectangular configuration in FIGS. 2 and 3. The upper second tray 36 generally has a rectangular shape with upstanding walls and a rail 38 extending around the upper top edge and laterally outward. The rail 38 is intended to rest upon a track 34 provided on opposite lateral sides of the upper open end of the housing 22. As such, the upper second tray 36 may be positioned at different locations along the length supported on the top edge of the top access opening 32 of the storage compartment 30. The upper second tray 36 may slide on tracks 34 upon the rails 38 to any of a number of forward or rearward positions. The upper second tray 36 is shown in a first forward position in FIGS. 2 and 3 substantially covering the open access portion 32A when the armrest lid 24 is in the closed position. The upper second tray 36 may be moved vehicle rearward and may expose the storage compartment 30 or a lower first tray 40, also referred to as a media tray, which is provided below the upper second tray 36.

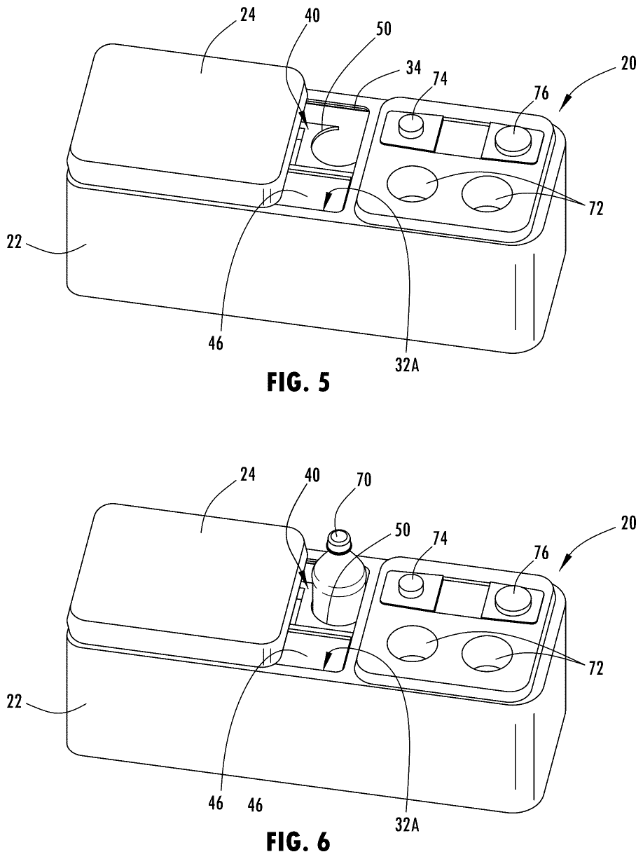

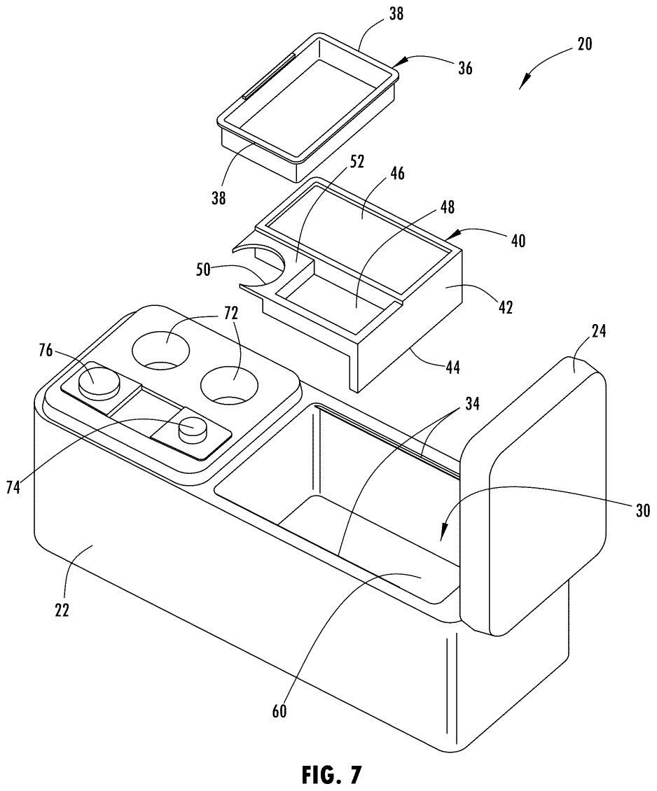

The lower first tray 40 may rest on the bottom 60 of the storage compartment 30, according to one example. According to another example, the lower first tray 40 may be supported by a pair of tracks and rails similar to the engagement of the upper second tray 36. The lower first tray 40 has upstanding walls 42 and a top surface that includes a first recessed tray 46 and the second recess tray 48 that may be configured to hold cargo items such as media devices, for example. The lower first tray 40 is further configured to include a cup holder 50 which is generally shown formed on a forward end of the lower first tray 40 and shaped with a cylindrical opening to receive a container, such as a drink container. The cup holder 50 is shown in one example having the cylindrical cutout shape without any lower sidewalls or bottom structure; however, it should be appreciated that the cup holder 50 may have other configurations and may include sidewalls and a bottom supporting structure to further support a container. It should further be appreciated that the lower first tray 40 may include one or more cup holders, preferably having the one or more cup holders positioned on the forward end of the lower first tray 40, such that one or more cup holders are presented in the exposed open access portion 32A when the armrest lid 24 is in the closed position as shown in FIGS. 4 and 5. As seen in FIG. 6, a drink container 70 may be disposed and supported within the cup holder 50 when the armrest lid 24 is in the closed position, thereby allowing access to the drink container 70 with the armrest lid 24 closed to thereby make additional cup holders available.

The center console 20 is further shown having additional cup holders 72 provided in the vehicle forward end of the motor vehicle 10, generally forward of the storage compartment 30. By providing one or more additional cup holders 72 on the lower first tray 40, a greater number of drink holders are made available and easily accessible in the motor vehicle 10.

Accordingly, the vehicle console 20 advantageously provides for a lower first tray 40 having one or more additional cup holders 72 that may be made available even when the armrest lid 24 of the center console 20 is in the closed position.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle console comprising:
a housing having sidewalls defining a storage compartment having a top access opening of a first size having a first length;
a lid coupled to the housing and moveable between an open position and a closed position, the lid having a second size with a second length that is less than the first length so as to expose a portion of the top access opening when the lid is in the closed position; and
a first tray disposed within the storage compartment and configured with a cup holder located below the exposed open top such that a container when placed in the cup holder is exposed.

2. The vehicle console of claim 1, wherein the exposed open top is on a vehicle forward portion of the top access opening.

3. The vehicle console of claim 2, wherein the lid pivots about a hinge at a rearward portion of the housing.

4. The vehicle console of claim 1, wherein the tray further comprises one or more open tray portions.

5. The vehicle console of claim 4, wherein the first tray comprises first and second open tray portions.

6. The vehicle console of claim 1, further comprising a second tray disposed above the first tray, wherein the second tray is configured to be positioned within the exposed open top and moveable to a position below the lid.

7. The vehicle console of claim 6, wherein the second tray is supported on a track proximate the top access opening.

8. The vehicle console of claim 7, wherein the first tray is supported on a bottom of the storage compartment.

9. The vehicle console of claim 1, wherein the top access opening and the lid are generally rectangular.

10. The vehicle console of claim 1, wherein the console is a center console configured to be positioned between the first and second seats in the vehicle.

11. A vehicle comprising:
a first seat;
a second seat spaced from the first seat; and
a center console located between the first and second seats, the center console comprising:
a housing having sidewalls defining a storage compartment having a top access opening of a first size having a first length;
a lid coupled to the housing and moveable between an open position and a closed position, the lid having a second size with a second length that is less than the first length so as to expose a portion of the top access opening when the lid is in the closed position; and
a first tray disposed within the storage compartment and configured with a cup holder located below the exposed open top such that a container when placed in the cup holder is exposed.

12. The vehicle of claim 11, wherein the exposed open top is on a vehicle forward portion of the top access opening.

13. The vehicle of claim 12, wherein the lid pivots about a hinge at a rearward portion of the housing.

14. The vehicle of claim 11, wherein the tray further comprises one or more open tray portions.

15. The vehicle of claim 14, wherein the first tray comprises first and second open tray portions.

16. The vehicle of claim 11, further comprising a second tray disposed above the first tray, wherein the second tray is configured to be positioned within the open top portion and moveable to a position below the lid.

17. The vehicle of claim 16, wherein the second tray is supported on a track proximate a top of the top access opening.

18. The vehicle of claim 17, wherein the first tray is supported on a bottom of the storage compartment.

19. The vehicle of claim 11, wherein the top access opening and the lid are generally rectangular.

20. The vehicle of claim 11, wherein the console is a center console configured to be positioned between the first and second seats.
